(19) United States
(12) Patent Application Publication
(10) Pub. No.: US 2013/0054700 A1
(43) Pub. Date: Feb. 28, 2013

(54) MESSAGE-BASED SYSTEM FOR REMOTE CONTROL AND CONTENT SHARING BETWEEN USERS AND DEVICES

(71) Applicants: Nizar Allibhoy, Northridge, CA (US); L. Dane Elliott, Centennial, CO (US); Karim Moti, Northridge, CA (US)

(72) Inventors: Nizar Allibhoy, Northridge, CA (US); L. Dane Elliott, Centennial, CO (US); Karim Moti, Northridge, CA (US)

(73) Assignee: TELEPOP, INC., Northridge, CA (US)

(21) Appl. No.: 13/593,376

(22) Filed: Aug. 23, 2012

Related U.S. Application Data
(60) Provisional application No. 61/526,610, filed on Aug. 23, 2011.

(51) Int. Cl. G06F 15/16

(52) U.S. Cl. 709/204

(57) ABSTRACT

A system and method that allows a user viewing an offer to send the offer to another of the user's network enabled devices is presented. The system and method also allows the user to send the viewed offer to one or more other persons known by the user.

### CROSS-REFERENCES TO RELATED APPLICATIONS

This application claims priority from provisional Application No. 61/526,610, filed Aug. 23, 2011 incorporated by reference in its entirety.

### BACKGROUND

This invention relates to a method of sharing advertising offers and other digital content among users of a network. More specifically, the invention is directed to a system and method where a user, when presented with an offer over a network, can “throw” the offer to another device for viewing the offer. Alternatively, the offer can be thrown to a second user so that the second user may view the offer.

Offers and other forms of advertising are currently presented to network users in a variety of forms. For example, almost every web page will have advertisements embedded in the web page. The same is true for content delivered via social media sites, such as Facebook and the like. Typically, these advertisements, which hereinafter are called “offers,” must be clicked on by the viewer if the viewer wants more information or to visit the web site that is pointed to by an embedded link in the offer.

Such a system was useful in the days when viewing web pages was only possible from a computer or other relatively immobile source. Today, however, web pages are routinely viewable on televisions, mobile telephones and other network enabled devices.

One problem with viewing offers in today's internet environment is that many viewers first encounter the offer on a mobile device, or other device, where obtaining further information about the offer is inconvenient, due to, for example, the small size of the viewing screen on most mobile devices, or where storage of the information is not available, such as when the offer is viewed on a television, or where the current viewing device is not connected, wirelessly or otherwise, to a printer.

Additionally, up until recently there has been no convenient way to share offers between friends or acquaintances, other than sending them an email with a link to the offer when a viewer was presented with an offer that he or she thinks might also interest someone in their social circle or group.

What has been needed, and heretofore unavailable, is a system or method for sharing offers viewed on a network page with other devices under the control of the viewer, or with other persons in the viewer's social group. Such a system and method would be embodied in software that may be embedded in a device, web page or other content, and which also would be agnostic as to the device or network upon which it is being operated. The present invention satisfies these, and other needs.

### SUMMARY OF THE INVENTION

In its most general aspect, the present invention provides for real-time and time-delayed communication between devices, including through peer-to-peer direct channel and through an intermediary channel. The communication messages can include a wide range of items, including sending web URLs, video URLs, commands to control action on the target device, play lists, text, multimedia messages, etc. The primary use of this communication is to allow User A to share a message item from Device A (such as, for example, a mobile phone, tablet computer, a connected TV) to Device B (or to multiple other devices). The other device may be User A's or a different user's. The device has software code embedded or in an application that also listens or polls the system in order to receive any message intended for that device or account. The software also has the logic included to act on the messages in a device-appropriate manner. The message item may be transmitted directly from one device to another, or it may be relayed through a message channel that one or more other devices may have permission to listen to. This message channel may be persistent or transient, that is, only set up for transmission of the message item. To establish these message channels, users can register their devices into their user account in a management system and also link user accounts together (either user-to-user or through a public forum). The user also has security and privacy controls to restrict what devices and users can communicate with that user's account and devices. The system monitors communication to set up and tear down the channels as needed.

In another aspect, the present invention includes a system for providing a capability of a user to provide a link to content being viewed by the user on a first device to a second device or user; comprising: a server configured to provide a database of registrations of devices and users, wherein the first device, user, and second device or user are registered in the database of registrations, and wherein the server is configured to provide a communications path between registered users and devices, and also configured to place a notification on a display of the second device to notify the second user that content is available from the first device, and wherein clicking on the notification sends a request to the server to provide the content represented by the notification to the second device.

In yet another aspect, the present invention includes a method for sharing content viewed on one device with another device or user, comprising: registering a first device with a management server; registering a second device or user with the management server; initiating a code instance on the first device, the code instance providing for identification of content to be communicated to the second device or user through a message channel opened between the first device and the second device or user through the management server; and communicating the identified content to the second device or user.

In one alternative aspect, the message channel is a direct connection between the second device or user. In another alternative aspect, the message channel is a private channel. In still another alternative aspect, the message channel is a public channel.

In another aspect, the content is an offer to a user to purchase or view merchandise or other content.

In yet another aspect, the message channel is opened between the first device and a second user participating on a social network. In still another aspect, the second user may use tools available on the social network for interacting with the offer.

In a further aspect, the communicated content may be viewed simultaneously on the first device and on the second device. In another further aspect, the communicated content may be viewed simultaneously on the first device and by the second user.

In a still further aspect, the present invention includes maintaining a history of the communicated content.

In yet another aspect, content communicated over the public channel may be viewed by any user registered with the management server. Still another aspect of the present invention includes displaying a notification on the second device that the content has been communicated to the second device.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1 is a graphic representation of an embodiment of the present invention.

FIG. 2 is a graphic representation of message channels formed by an embodiment of the present invention providing for sharing of digital content between devices controlled by a user and between users in a personal domain and a public domain.

FIG. 3 is a representation of an offer screen presented to a user in accordance with an embodiment of the present invention.

FIG. 4 is a representation of an expanded offer screen of FIG. 3.

FIG. 5 is a representation of a detailed offer presented to a user after clicking on the expanded offer screen of FIG. 4.

FIG. 6 is a representation of a screen presented to a user that directs the user to a web site to register to receive the offer of FIG. 5.

FIG. 7 is a representation of a screen reporting that the offer of FIG. 5 has been successfully thrown to the user's device.

### DETAILED DESCRIPTION OF THE PREFERRED EMBODIMENTS

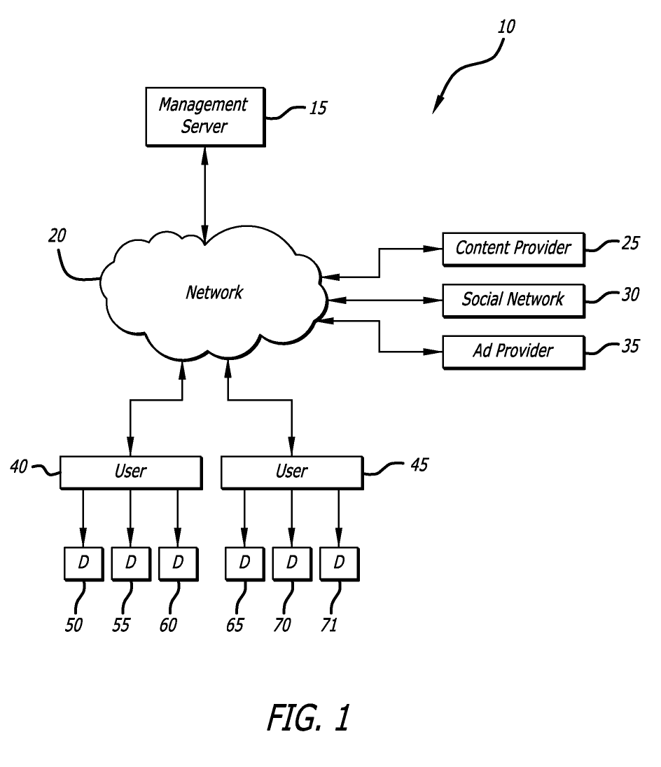

Referring now to the drawings in detail, in which like reference numerals indicate like or corresponding elements among the several figures, there is shown in FIG. 1 a system 10 that facilitates real-time and time-delayed communication between devices, including through peer-to-peer direct channel and through an intermediary channel.

In this system, a management server 15 that controls the various aspects of the system is connected to a network, such as the Internet 15. Also connected to the network 15, and accessible by users connected to the network, are servers and databases that provide content 25, social networks 30, such as, for example, Facebook, and ad providers 35, such as Netads and the like. This list is not intended to a complete list, but is only exemplary of the various types of information, advertisement and offer providers that may accessed through the network by a user.

FIG. 1 also shows a pair of users 40, 45. Each of these users (there may be more than the two users shown) may have more than one device through which the user connects with the network. For example, user 40 may have devices 50, 55, 60 which may be, for example, an Internet enabled television, a smart phone and a computer. Similarly, user 45 may also have multiple devices 65, 70, 75, which may be the same or different from the devices of user 40.

As will be discussed more fully below, the present invention comprises software that may be embedded on the user's devices, or it may reside in the cloud, that is, on a server that is accessible through the Internet or other network. The software of the present invention provides a system and method wherein a user 40 may view an offer on one of his devices, say device 50, and then, using the various embodiments of the present invention, send (“throw”) the offer to another of his devices, say device 60. There are many reasons why user 40 may wish to throw the offer to another device, such as, for example, when it would be inconvenient to respond to the offer on device 50 because device 50 may not have an interface that is easy to use in such a situation, or where the viewing capabilities of device 50 are inferior, or at least not as convenient, as the viewing capabilities of device 60. One example of such a situation may be where device 50 is television, with an interface that is difficult to navigate. In this case user 40 throws the offer to device 60, which may be a desktop or laptop computer, having an interface that is easier to navigate.

The communication messages and offers contemplated by the various embodiments of the present invention can include a wide range of items, including sending web URLs, video URLs, commands to control action on the target device, play lists, text, multimedia messages, and the like. The primary use of this communication is to allow user 40 to share a message item from a device 50 (for example, a mobile phone, tablet computer, a connected TV) to device 55 (or to multiple other devices). The other device may belong to user 40 or a different user, such as user 45.

Each of the user's devices have software code embedded in the processor or memory of the device, or in an application residing on the device, that listens or polls the system (under control of the management server 15) in order to receive any message intended for that device or account. The software also has the logic included to act on the messages in a device-appropriate manner.

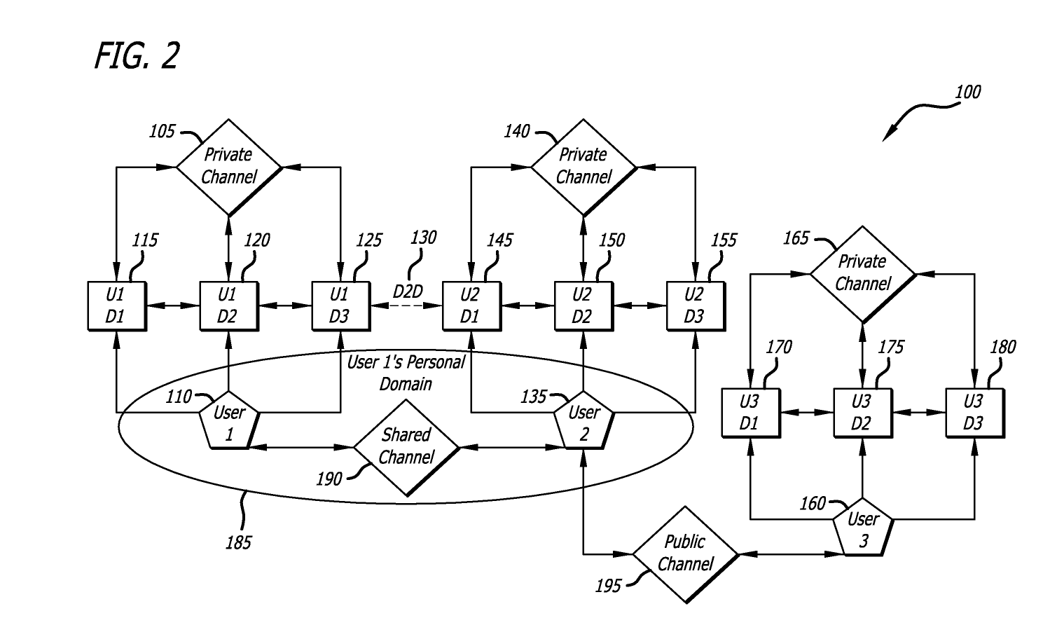

FIG. 2 is a graphical representation illustrating a system 100 showing the message channels utilized the by the various embodiments of the present invention. In such a system, a message item may be transmitted directly from one device to another, or it may be relayed through a message channel that one or more other devices may have permission to listen to. This message channel may be persistent or transient, that is, only set up for transmission of the message item. To establish these message channels, users can register their devices into their user account in the management server (FIG. 1) and also link user accounts together (either user-to-user or through a public forum). The user also has security and privacy controls to restrict what devices and users can communicate with that user's account and devices. The system monitors communication to set up and tear down the channels as needed.

For example, when user 110 registers with the management server, a private channel 105 may be set up between devices 115, 120 and 125. In this manner, user 110 can throw content and offers from one registered device to another. Similarly, user 135 may set up a private channel 140 between devices 145, 150 and 155; and user 160 may set up a private channel 165 by registering devices 170, 175 and 180.

Users 110 and 135 may also establish a peer-to-peer channel 130 between the devices registered by user 110 and user 135. Alternatively, user 110 may set up a personal domain 185, such as a local network with his home, and establish a shared channel 190 with user 135. One can imagine that such a personal domain could be a home network and user 135 is a spouse, child, or other member of the household.

In another embodiment of the present invention, user 135 may be connected to user 160 through a public channel 195. In such a case, user 160 may be a friend or other person with whom user 135 has an association. In any of these cases, the channel are set up and managed by software running on the management server.

Before using the service, users sign up for an account by accessing the management server (FIG. 1). Users can access a sign-up page through any device that supports the application or programming code that may be downloaded from the management server. The users provide necessary information, such as, for example, an email, username, password, and the like, in order to establish an online account with the management server. Once the user has finished registering and setting up an account, the program running on the management server will associate the device being used to access the management server with the user's account.

Once the user has initially signed up on one device, the user will have the option to add more devices to their account to enable sharing between the devices. The user will have to access the service on a supported device and log in to their account so that the service can associate the device with the account.

If a user owns many devices that are registered with the system, such as, for example, connected televisions, smart phones, tablets, computers, and the like, the user will be able to send and receive messages to these devices through the system. This sharing is enabled by initiating an instance of code embodying the various embodiments of the present invention on the device, and registers their devices with the service. The instance of code, or program, may reside in an application (app), that may be embedded in the device by the manufacturer of the device, provided by the manufacturer of the device for activation by the user, or may be downloaded from the management server by the user when the user accesses the management server for the first time.

In various embodiments, the software programs comprising the system may be embedded by third parties within their products or websites. For example, a website operator may embed HTML and/or JavaScript code on their website which would allow video, offers, or other content, to be throwable by their users between devices and users using the network controlled by the management server. Similarly, such programming code may also be embedded in a mobile application or an application for use on an enabled television.

Once user account setup is complete and all of the user's devices are registered under their account, they are now freely able to send and receive messages on all of their devices. The devices can be connected in two ways: by a direct device to device connection or a device to container connection. When doing a direct connect, the user must choose which one of their devices the user wants to connect to and then once that device has connected, the user can freely send messages back and forth between the devices.

The user may also connect to a channel if the user wants to store items the user likes which can be accessed by any of their devices. For example, if the user finds a video they like on his or her registered mobile phone and would like to view it on his or her registered television, the user can open up a direct connection to their television and send the video to the television. Alternatively, if the user would like to save the video, the user can send the video to a container and access it at a later time. In the context of the present invention, the term “container” refers to a memory that is accessible to the user for storage and retrieval of digital content. For example, registering with the management server may provide the user with an allocation of memory residing on the server, or at least accessible by the management server, which may be used by the user to store items selected from a registered device.

One example of the capabilities enabled by the software programs of the various embodiments of the present invention is where the user sees a video on a web site or app on their tablet computer and “throws” it to the connected TV. To accomplish this “throw”, the user may drag an icon representing the video onto an provided on the tablet when the table was registered with the system. Such an icon may be, for example, Telepop-branded icon or another location on the screen. The tablet computer's software understands that this is a video URL and communicates it to the user's account. The user has also registered a connected TV device (one that can run applications or widgets). The software code embedded in the connected TV or an app on the TV is listening or polling for any messages on its approved channels. When it receives this URL for a video, the TV app displays an indicator to the user that a new message or item is available. The user then can use his remote control to open the app and play back the video. The software on the TV app understands the type of message it is receiving and then has logic to decide how to present it to the user and to display it if the user chooses to.

As described previously, the service also allows users to share messages/content with other registered users. Referring again to FIG. 2, user 110 can explicitly request a connection with user 135's account. A user's device can communicate with another user's through a direct connection 130 or through a channel 190, 195. If a user selects the direct connection method, both users will go through a discovery/authentication process managed by the application software and management server so that the connection between the users can be established.

If a user wants to use the shared channel method, the user sets up a shared channel and selects users that they will share the channel with. The user can drop multiple items into the channel that they want to share and save. This explicit setting up of the channel allows for future re-use through a saved channel. Channels can also be set up automatically when accepting other users into one's connections, and these channels are automatically available in the system for use without requiring users to establish them each time when needed. The channel method also allows for synchronous viewing of content (simultaneously watching videos with multiple users).

Similar to the inter-device communication within a single user's account, a user may select an item (such as a video on a web site) to “throw” or share with the user's established connections (other users). The user may be presented with a dialog box or other method that poses a decision about which channels to communicate with on this request. The other user would also have software on his registered devices that listen for messages on channels.

One example of such a use is to share synchronously with friends. For example, user 110 is shopping on their connected TV and wants to share an item with a friend, user 135, that is linked in the system. User 110 “throws” the item for sale over to user 135 by activating the software application of one embodiment on the present invention on the connected TV, and directing the item to user 135. In this manner, both user 110 and user 135 may view the item.

Users will also have the option to share items with the general public. A user can place items into a public channel 195 which is viewable by any of the registered users in the system. Users can also submit items to various social networking sites, which can publish the messages to a broader audience. Using existing social media, users can also interact with the content that is submitted. For example, connected users may comment on the thrown content, share it with others, or take other actions commonly available on social media networks.

In another embodiment, the channels established by the users may also contain a history of past interactions between the users. For example, so if user 135 has received messages or content from user 110 over a time period, then user 135 may request to view a history of interactions on the shared channel. For example, if user 135 remember that he had previously received a link to a video that he wanted to watch again, user 135 can opens the application of the present invention to view past messages. He searches for the video link sent a few days ago and, when the link is found, may initiate playback of the video on his connected TV by clicking on or otherwise activating the link.

The content that may be thrown to other devices or users using the various embodiments of the present invention include, without limitation, images, videos, shopping items, applications, widgets, text, links, pointers into third party applications, contact information and commands that may remotely control another connected device. This content may be thrown to, without limitation, mobile/smart telephones, connected televisions, BLU-RAY® (Blu-ray Disc Association) players, third party boxes, such as ROKU® (Roku Inc.), APPLETV® (Apple Inc.), BOXEE® (Boxee Inc.) and the like, table computers, computers, servers, network appliances and the like.

User may also “re-throw” content the user receives from another user. In this context, the underlying content reference or link remains the same and any content protection rules associated with the content remain enforceable. For example, a video may be purchased from Studio A. The content protection rules associate with that purchase may allow the user to share it with the user's friends. If the user throws the video to a friend, the friend should be able to view the video. If the friend then attempts to thrown the video to a third person, the protection rule will prevent the third person from viewing the video and will in fact prompt the third person to purchase the video. Thus, even though the content may be thrown across devices and users, the underlying integrity of the content, including and content protection rules, is preserved.

The various embodiments of the present invention also provide for establishing channels between devices that user varying operating platforms or systems. For example, content may be thrown to devices running iOS® (Cisco), ANDROID™ (Google Inc.), TV platforms, GOOGLE TV® (Google Inc.), OSX, WINDOWS® (Microsoft Corp.) and LINUX™ (Linus Foundation). The system also provides compatibility with various social media platforms, such as, without limitation, FACEBOOK® (Facebook Inc., SKYPE® (Skype Corp.), REDDIT® (Reddit Inc.), and the like.

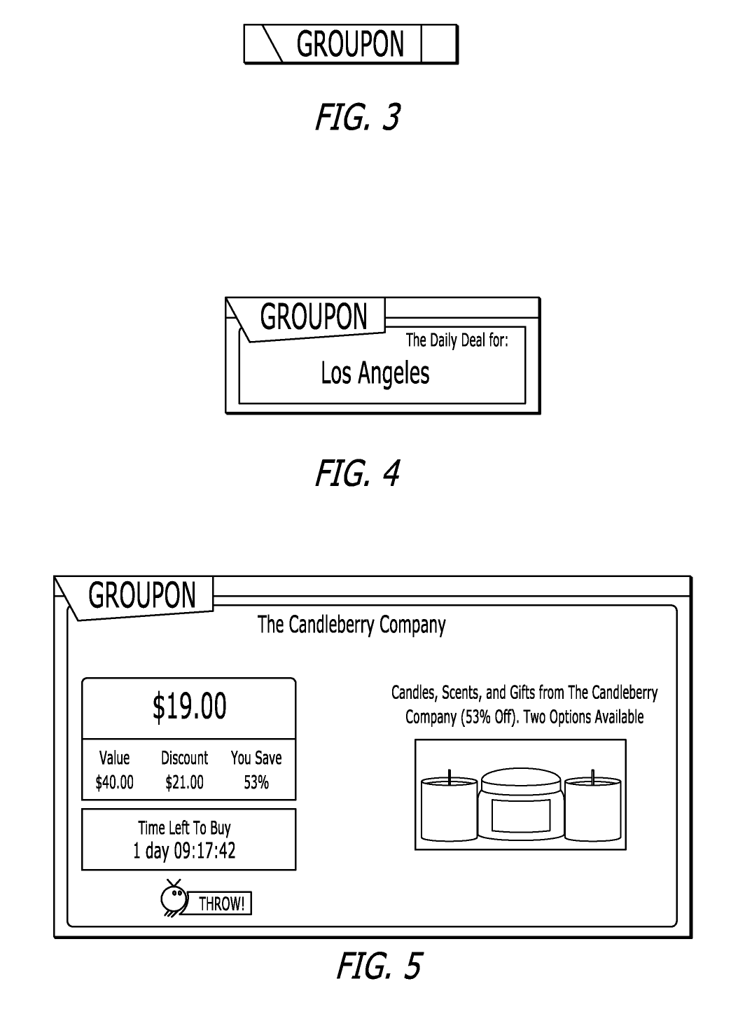

FIGS. 3-7 illustrate use of the an embodiment of the present invention that has been established to operate in one specific advertisement environment. This embodiment of the present invention allows an advertiser, for example, to throw offers to a user. For example, a user may be presented with ads that, when clicked, instead of linking directly to a web site that then presents information related to the ad, may activate the application program of an embodiment of the present invention and provide the user with the opportunity to set up an account, if the user is not already a user, or to logon into his account and then throw the offer or ad to a specific device. Monitoring such throws may provide an income stream to the entity that is providing the software by more directly controlling and monitoring who such offers are delivered to.

For example, in FIG. 3, a user operating a connected and device is presented with an advertisement for GROUPON® (Groupon, Inc.). Clicking on GROUPON can expand the ad to allow the user to specify additional delimiting content, such as, for example, a location, as seen in FIG. 4.

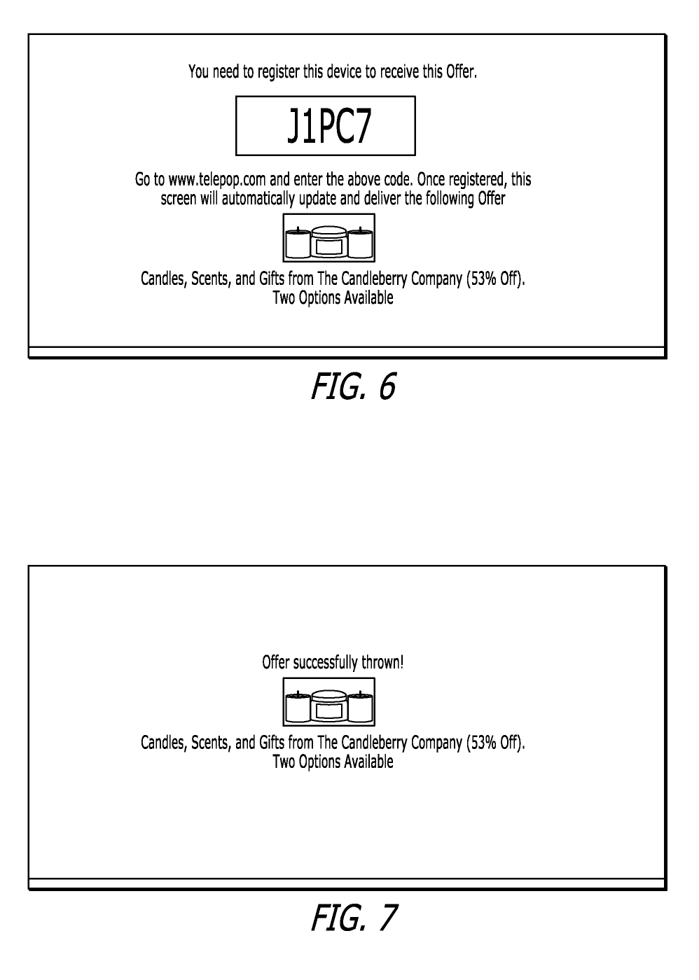

Clicking on the expanded presentation may result in the presentation of a specific offer, such as the offer for “The Candleberry Company” in FIG. 5. In this embodiment, the user may not be registered with the system yet, and the ad itself (or at least the application that is presenting the ad to the user) is programmed such that clicking on the ad results in the user being presented with a registration screen, as seen in FIG. 6. This allows the user to set up an account with the system and register the device. Once registration is complete, the specific offer is “thrown” to the user's registered device, as illustrated in FIG. 7.

While the above example has described an embodiment of the present invention for use in on particular ad environment, other such environments may also be used. For example, embodiments of the present invention may be used to present offers using the BRAVIA® (Sony Corp.) Internet Video (BIV) or Yahoo! Widget Engine—Broadcast Interactivity (Yahoo! is a registered trademark of Yahoo! Corporation) platforms, among others.

It will be understood that, in the various embodiments of the present invention, the notion of “content” is intended to be broad, and is also intended to be opaque the network that is the platform upon which the embodiments of the invention are operating. For example, a game developer may an embodiment of the present invention as a means of allowing a user to start a game on the user's mobile telephone, then throw the game session to the user's XBOX® (Microsoft Corp.) or PLAYSTATION® (Sony Corp.) when the user returns home, and then continue playing the game by simply shifting the state across the devices. The various embodiments of the present invention are not aware of, and are opaque to, what the actual content object is that is being thrown. The game developer may define the object and use API's (application programming interface) associated with the embodiments of the invention to transmit the game session across registered devices.

In addition, the various embodiments of invention are both platform and network agnostic. By this it is meant that content may be thrown across any device that is registered with the management server across any network. For example, a television program may be thrown from a tablet that is connected to the network through a telephone company to a television that is connected to a cable provider. Moreover, APIs of the various embodiments of the invention may be embedded with a web page or application and operate within the security confines provided by the web page or application.

While several particular forms of the invention have been illustrated and described, it will be apparent that various modifications can be made without departing from the spirit and scope of the invention.

We claim:

1. A system for providing a capability of a user to provide a link to content being viewed by the user on a first device to a second device or user; comprising:
a server configured to provide a database of registrations of devices and users, wherein the first device, user, and second device or user are registered in the database of registrations, and wherein the server is configured to provide a communications path between registered users and devices, and also configured to place a notification on a display of the second device to notify the second user that content is available from the first device, and wherein clicking on the notification sends a request to the server to provide the content represented by the notification to the second device.

2. A method for sharing content viewed on one device with another device or user, comprising:
registering a first device with a management server;
registering a second device or user with the management server;
initiating a code instance on the first device, the code instance providing for identification of content to be communicated to the second device or user through a message channel opened between the first device and the second device or user through the management server; and
communicating the identified content to the second device or user.

3. The method of claim 2, wherein the message channel is a direct connection between the second device or user.

4. The method of claim 2, wherein the message channel is a private channel.

5. The method of claim 2, wherein the message channel is a public channel.

6. The method of claim 2, wherein the content is an offer.

7. The method of claim 2, wherein the message channel is opened between the first device and a second user participating on a social network.

8. The method of claim 7, wherein the second user may use tools available on the social network for interacting with the offer.

9. The method of claim 2, wherein the communicated content may be viewed simultaneously on the first device and on the second device.

10. The method of claim 2, wherein the communicated content may be viewed simultaneously on the first device and by the second user.

11. The method of claim 2, further comprising maintaining a history of the communicated content.

12. The method of claim 5, wherein content communicated over the public channel may be viewed by any user registered with the management server.

13. The method of claim 2, further comprising displaying a notification on the second device that the content has been communicated to the second device.
